(19) United States
(12) Patent Application Publication
(10) Pub. No.: US 2016/0237647 A1
(43) Pub. Date: Aug. 18, 2016

(54) Arrangement of Components of a Cooling Unit in a Construction Machine

(71) Applicant: CATERPILLAR SARL, Geneva (CH)

(72) Inventors: Toru Imano, Tokyo (JP); Keigo Hara, Tokyo (JP)

(73) Assignee: Caterpillar SARL, Geneva (CH)

(21) Appl. No.: 15/025,511

(22) PCT Filed: Oct. 8, 2014
(86) PCT No.: PCT/EP2014/071562

§ 371 Date: Mar. 28, 2016

(30) Foreign Application Priority Data
Oct. 17, 2013 (JP) 2013-216204

(51) Int. Cl. E02F 9/08; B60K 11/08; B60K 11/02

(52) U.S. Cl. CPC E02F 9/0866; B60K 11/02; B60K 11/08; B60Y 2200/41; B60Y 2306/05

(57) ABSTRACT

To provide a cool wind to a heat exchanger for a supercharger powerful enough to cool it down on a construction machine, a cooler for a supercharger is mounted at the top of the stream on the flow of the cool wind and at the upper side of any other heat exchangers. A current plate is mounted under the cooler for the supercharger to regulate the flow of the cool wind that enters from air inlets and flows under the cooler for the supercharger, and to direct the cool wind into the cooler for the supercharger.

### TECHNICAL FIELD

The present invention relates to a technical field of construction machinery such as a hydraulic shovel in which a plurality of heat exchangers is mounted together as a cooling unit.

### BACKGROUND ART

In general, some construction machines such as hydraulic shovels are configured such that a plurality of heat exchangers such as a radiator for cooling engine cooling water, an oil cooler for cooling hydraulic oil, a supercharger cooler (also referred to as an intercooler, a charge air cooler, an after cooler, or ATTAC) for cooling compressed air generated in a turbo supercharger, and an air conditioning condenser is mounted together as a cooling unit in the construction machine, and those heat exchangers are cooled using cooling air that flows in as a result of rotation of a cooling fan. In such a construction machine, when a plurality of heat exchangers is arranged in the cooling unit, the supercharger cooler and the air conditioning condenser are preferably disposed on an upstream side in a direction in which cooling air flows because the supercharger cooler and the air conditioning condenser need to be cooled down to a lower temperature than the radiator and the oil cooler, and the supercharger cooler preferably avoids being disposed below other heat exchangers in terms of the layout of pipes connected to an engine supercharger. Thus, some construction machines have been known in which the supercharger cooler is disposed above the air conditioning condenser and in which the supercharger cooler and the air conditioning condenser are arranged upstream side of the radiator and the oil cooler in the cooling air flowing direction (see, for example, Patent Literature 1).

The cooling unit is disposed in a building cover of the construction machine, and air intakes for taking in air serving as cooling air are formed in an upper surface portion and a side surface portion of the building cover located upstream of the cooling unit in the cooling air flowing direction. In this case, a space between the air intake and the cooling unit, that is, the space located upstream of the cooling unit in the cooling air flowing direction, may remain an empty space if the machine body has a sufficient space (see, for example, Patent Literature 2). However, if the machine body has an insufficient space as in the case of a slewing hydraulic shovel, the space located upstream of the cooling unit may be used as a disposition space for a member such as an air cleaner (see, for example, Patent Literature 3).

Patent Literature 1: Japanese Patent Application Laid-open No. 2004-196191

Patent Literature 2: Japanese Patent Application Laid-open No. 2006-28873

Patent Literature 3: Japanese Patent Application Laid-open No. 2010-77634

However, if the member such as an air cleaner is disposed in the space located upstream of the cooling unit in the cooling air flowing direction as in the case of Patent Literature 3, the flow of cooling air may be hindered to make the amount of air flowing to the heat exchangers insufficient depending on the member disposed on the upstream side in the cooling air flowing direction. In particular, even though the supercharger cooler is disposed on the upstream side in the cooling air flowing direction because the supercharger cooler needs to be cooled down to a lower temperature than the radiator and the oil cooler, the member disposed upstream of the supercharger cooler may prevent an intended amount of cooling air from being provided. Moreover, an insufficient amount of cooling air flowing to the supercharger cooler may disadvantageously lead to an insufficient amount of cooling air flowing to the heat exchangers disposed downstream of the supercharger cooler in the cooling air flowing direction, which results in the problem to be solved by the present invention.

### DISCLOSURE OF THE INVENTION

With the foregoing in view, the present invention has been created in order to solve these problems. An invention of claim 1 is a construction machine in which a plurality of heat exchangers including a supercharger heat exchanger is disposed in a building cover as a cooling unit, and air intakes are formed in an upper surface portion and a side surface portion of the building cover located upstream of the cooling unit in a cooling air flowing direction, wherein the plurality of heat exchangers in the cooling unit is arranged in such a manner that upstream side heat exchangers including the supercharger heat exchanger are disposed most upstream in the cooling air flowing direction and that the supercharger heat exchanger is disposed at a highest position among the upstream side heat exchangers, and a current plate is provided below the supercharger heat exchanger, the current plate regulating a flow of cooling air flowing in through the air intake located upstream of the supercharger heat exchanger in the cooling air flowing direction and toward below the supercharger heat exchanger to introduce the cooling air into the supercharger heat exchanger.

An invention of claim 2 is the construction machine of claim 1, wherein the current plate is attached to an upper end portion of an attachment member for attaching the heat exchanger disposed below the supercharger heat exchanger to a frame of the cooling unit.

An invention of claim 3 is the construction machine of claim 1 or claim 2, wherein a regulation plate is provided above the supercharger exchanger, for regulating a flow of cooling air flowing in through the air intake in the upper surface portion of the building cover and toward above the supercharger heat exchanger to introduce the cooling air into the supercharger heat exchanger.

An invention of claim 4 is the construction machine of claim 3, wherein the air intake in the upper surface portion of the building cover is formed in a grating installed on the upper surface portion of the building cover, and the regulation plate is attached to the grating.

An invention of claim 5 is the construction machine of any one of claims 1 to 4, wherein a louver for directing cooling air flowing in through the air intake toward the supercharger heat exchanger is provided in the air intake in the side surface portion of the building cover located upstream of the supercharger heat exchanger in the cooling air flowing direction.

An invention of claim 6 is the construction machine of any one of claims 1 to 5, wherein a louver for directing cooling air flowing in through the air intake toward the supercharger heat exchanger is provided in the air intake in the upper surface portion of the building cover.

An invention of claim 7 is the construction machine of claim 6, wherein the air intake in the upper surface portion of the building cover is formed by a gap between flat bars of a grating installed on the upper surface portion of building cover, and the flat bars are tilted to form the louver.

According to the invention of claim 1, the current plate allows cooling air flowing in through the air intake located upstream of the supercharger heat exchanger in the cooling air flowing direction to be restrained from flowing toward below the supercharger heat exchanger. This enables the cooling air to be introduced into the supercharger heat exchanger. As a result, a needed amount of cooing air can be reliably supplied to the supercharger heat exchanger.

The invention of claim 2 allows the current plate to be provided utilizing the attachment member for the heat exchanger disposed below the supercharger heat exchanger without the need for a dedicated attachment member or space for the current plate. The invention of claim 2 can contribute to simplifying the structure of the construction machine and reducing the costs of the construction machine.

According to the invention of claim 3, the regulation plate allows prevention of waste of a flow, toward above the supercharger heat exchanger, of cooling air flowing in through the air intake in the upper surface portion of the building cover. This enables an increase in the amount of cooling air supplied to the supercharger heat exchanger.

The invention of claim 4 allows the regulation plate to be provided utilizing the grating without the need for a dedicated attachment member or space for the regulation plate. The invention of claim 4 can contribute to simplifying the structure of the construction machine and reducing the costs of the construction machine.

The invention of claim 5 allows cooling air flowing in through the air intake in the side surface portion of the building cover to be reliably supplied to the supercharger heat exchanger.

The invention of claim 6 allows cooling air flowing in through the air intake in the upper surface portion of the building cover to be reliably supplied to the supercharger heat exchanger.

The invention of claim 7 allows the louver to be formed using the flat bars of the grating without the need for a separate member or space for the louver. The invention of claim 7 can contribute to simplifying the structure of the construction machine and reducing the costs of the construction machine.

### BRIEF DESCRIPTION OF THE DRAWINGS

FIG. 1 is a plan view of an upper slewing body.

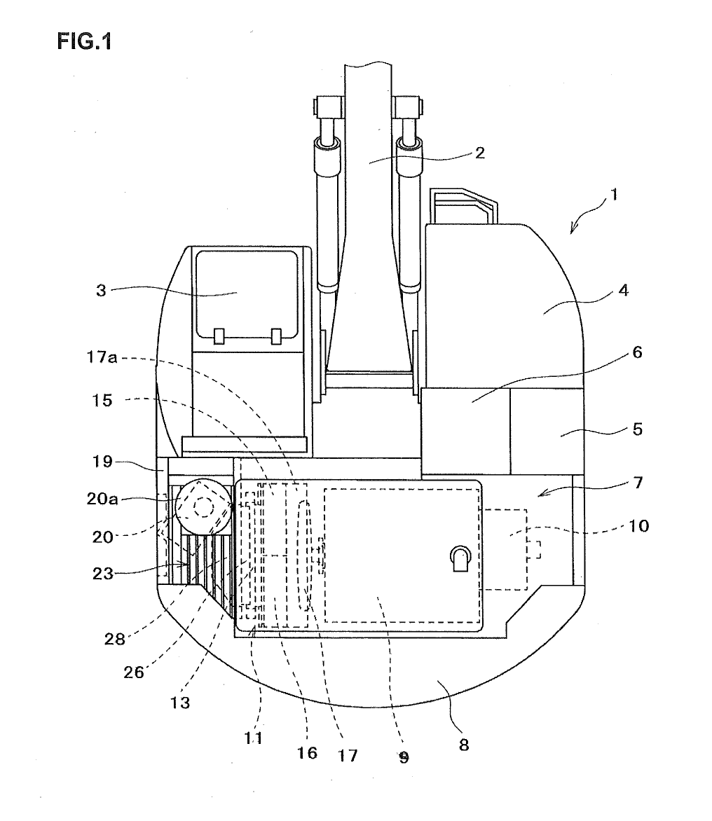

FIG. 2 is a view of a left portion in an engine room as viewed from a rear side of the engine room.

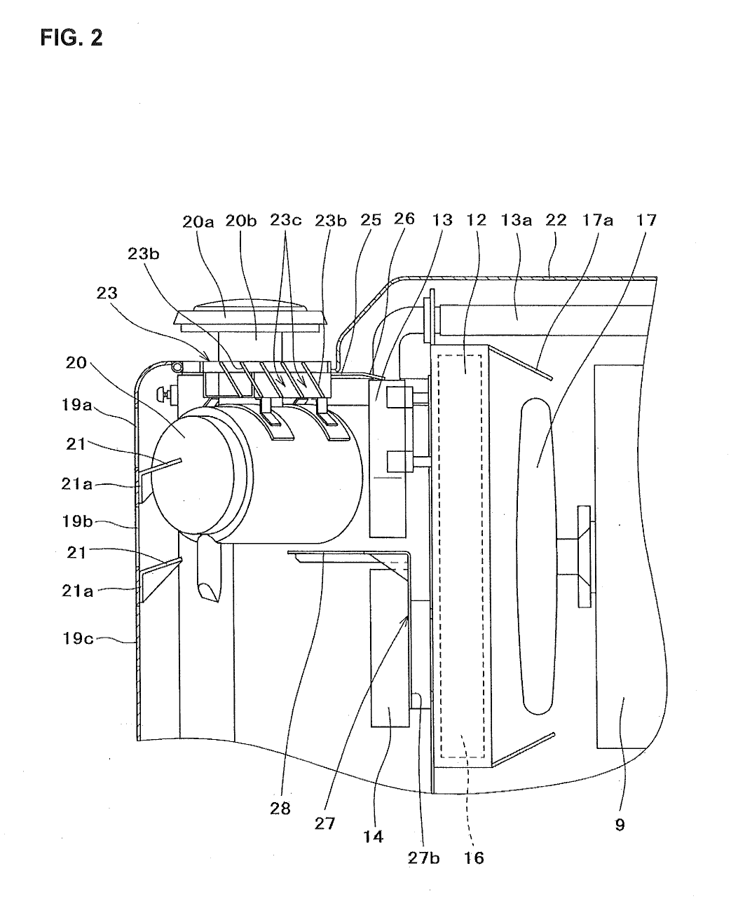

FIG. 3 is a perspective view of the left portion in the engine room.

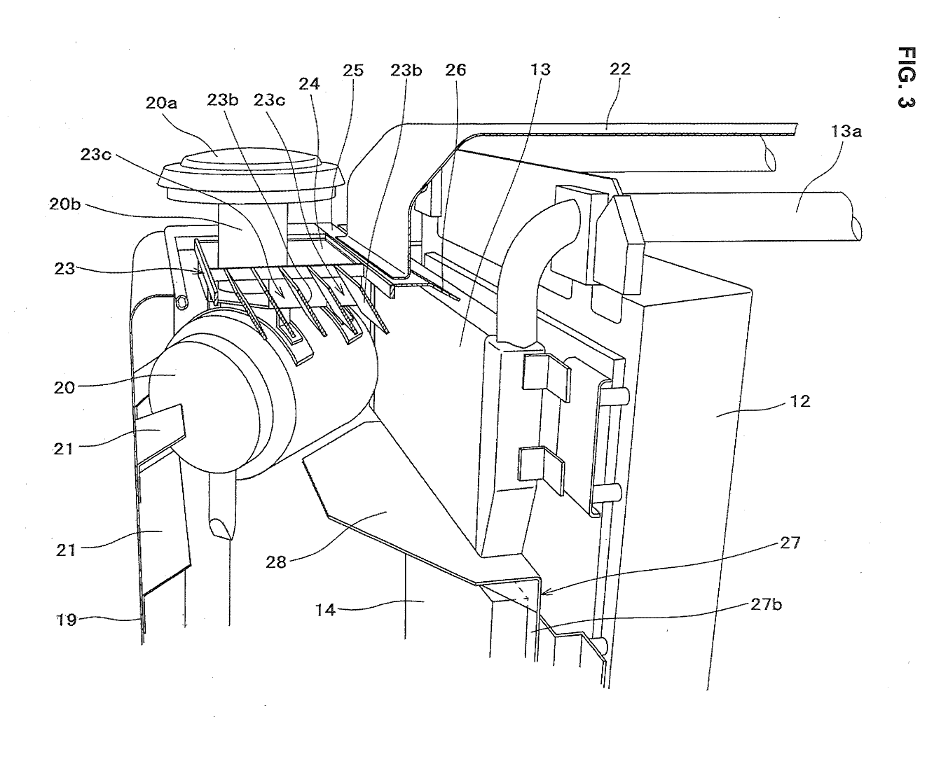

FIG. 4 is a perspective view of a side door.

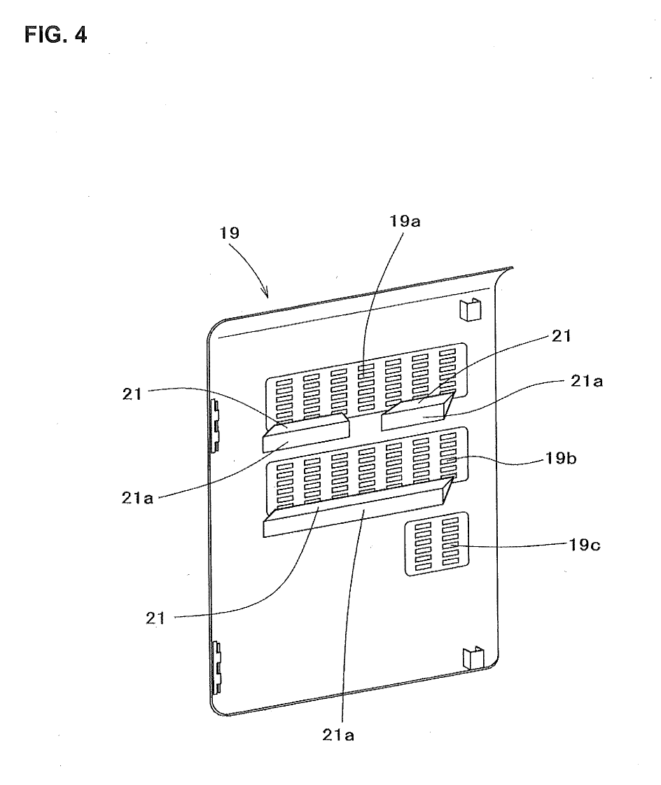

FIG. 5 is a perspective plan view of the left portion of the engine room (an engine hood is omitted).

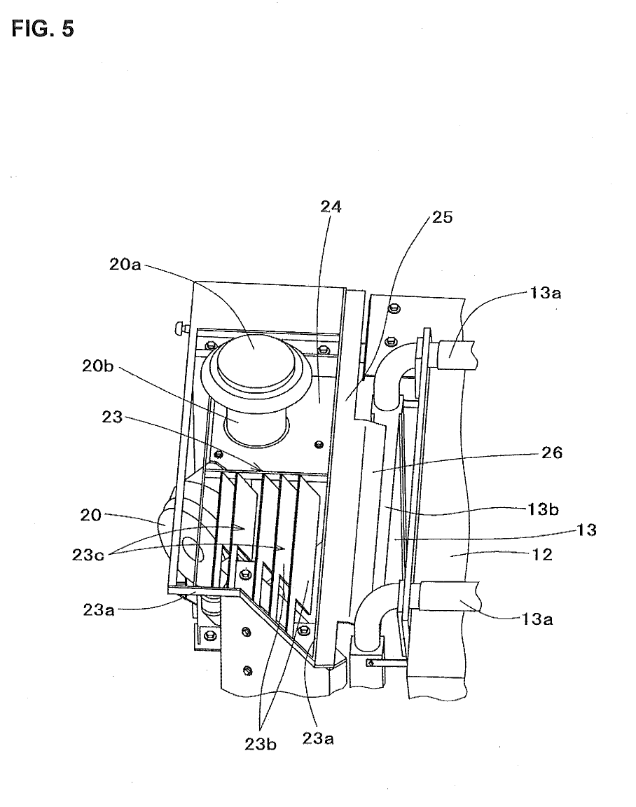

FIG. 6 is a perspective view showing how a current plate is disposed.

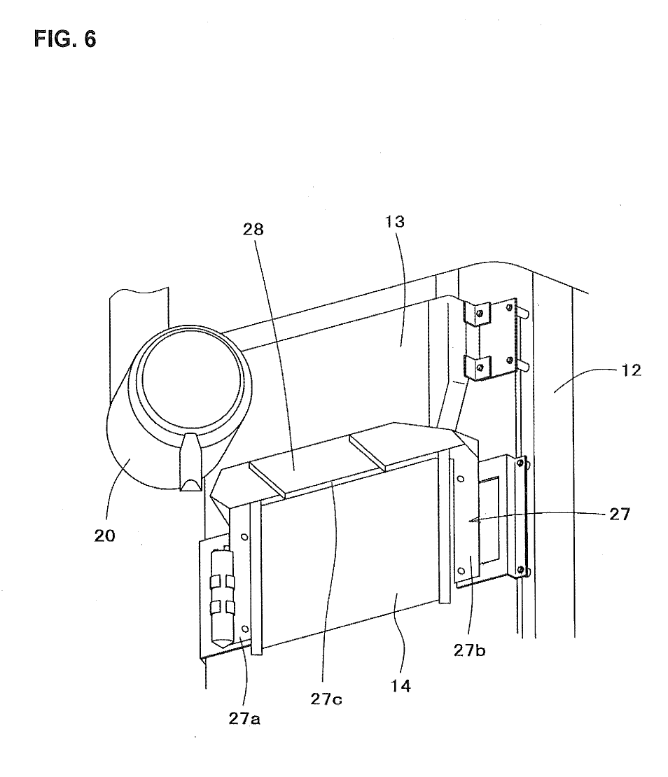

### BEST MODE FOR CARRYING OUT THE INVENTION

An embodiment of the present invention will be described below based on the drawings. In the figures, reference numeral 1 denotes an upper slewing body of a hydraulic shovel, an example of a construction machine. The upper slewing body 1 includes a front work section 2 axially supported at a base end portion of the front work section 2 in a laterally central portion of a front half side of the upper slewing body 1 so as to allow the front work section 2 to rise and lie freely, a cab 3 mounted in a left portion of the front half side, and an equipment housing chamber 4, a fuel tank 5, a hydraulic oil tank 6, and the like disposed in a right portion of the front half side; equipment such as a control valve (not shown in the drawings) is housed in the equipment housing chamber 4. Moreover, the upper slewing body 1 includes an engine room 7 disposed on a rear half side of the upper slewing body 1 and a counterweight 8 installed behind the engine room 7. A front-rear direction and a lateral direction in the description below correspond to the front-rear direction and lateral direction of the machine body (upper slewing body 1).

The engine room 7 includes an engine 9 housed in a laterally central portion of the engine room 7, a hydraulic pump 10 housed on a right side of the engine 9 and driven by the engine 9, and a cooling unit 11 housed on a left side of the engine 9. The engine 9 includes a supercharger (not shown in the drawings) that compresses air sucked into the engine 9.

The cooling unit 11 includes a plurality of heat exchangers assembled to a frame 12. According to the embodiment, the plurality of heat exchangers provided in the cooling unit includes a supercharger cooler (corresponding to a supercharger heat exchanger according to the present invention) 13 for cooling air compressed by the supercharger, an air conditioning condenser 14, a radiator 15 for cooling engine cooling water, and an oil cooler 16 for cooling hydraulic oil. These heat exchangers are adapted to be cooled by cooling air that flows in as a result of rotation of a cooling fan 17 connected to a crank shaft of the engine 9. In the figures, reference numeral 17a denotes a shroud that surrounds an area between the cooling fan and the frame 12 to regulate a flow of cooling air. Furthermore, reference numeral 13a denotes a pipe that connects the supercharger cooler 13 and the supercharger together. The pipe 13a is disposed so as to pass above the supercharger cooler 13, the radiator 15, and the oil cooler 16 to the supercharger for the engine 9.

In this case, the plurality of heat exchangers in the cooling unit 11 is arranged as follows. The supercharger cooler 13 and the air conditioning condenser 14 are juxtaposed to each other in the vertical direction so that the supercharger cooler 13 lies above the air conditioning condenser 14. The supercharger cooler 13 and the air conditioning condenser 14 are positioned on the upstream side in the cooling air flowing direction. The radiator 15 and the oil cooler 16 are positioned downstream of the supercharger cooler 13 and the air conditioning condenser 14 (closer to the cooling fan 17 than the supercharger cooler 13 and the air conditioning condenser 14). The supercharger cooler 13 and the air conditioning condenser 14 correspond to upstream side heat exchangers according to the present invention.

On the other hand, reference numeral 19 denotes an openable and closable side cover (corresponding to a building cover side surface portion according to the present invention) forming a left surface portion of the engine room 7. The side cover 19 is positioned upstream of the cooling unit 11 in the cooling air flowing direction. An air cleaner 20 is disposed between the side cover 19 and the supercharger cooler 13, that is, in a space located upstream of the supercharger cooler 13 in the cooling air flowing direction. The air cleaner 20 separates dust from air to supply clean air to the supercharger for the engine 9. The air cleaner 20 is cylindrical and is disposed so as to incline to the supercharger cooler 13. A cylindrical base of the air cleaner 20 positioned on a front side of the machine body lies in proximity to the supercharger cooler 13. A cylindrical base of the air cleaner 20 positioned on a rear side of the machine body lies in proximity to the side cover 19. Reference numeral 20a denotes a pre-cleaner.

The side cover 19 includes a first air intake 19a, a second air intake 19b, and a third air intake 19c formed in the side cover 19 and through which cooling air is taken into the engine room 7. The first, second, and third air intakes 19a, 19b, and 19c each include a plurality of horizontally long slits arranged in juxtaposition in the vertical direction and in the horizontal direction. The first and second air intakes 19a and 19b are formed in an upper half side of the side cover 19, that is, upstream of the supercharger cooler 13 in the cooling air flowing direction and in juxtaposition in the vertical direction. The third air intake 19c is formed in a lower half side of the side cover 19, that is, upstream of the air conditioning condenser 14 in the cooling air flowing direction. Furthermore, the first and second air intakes 19a and 19b are long in the horizontal direction, and the third air intake 19c is formed to be narrower than the first and second air intakes 19a and 19b in the horizontal direction. Moreover, louvers 21 inclined such that a leading end of each of the louvers 21 faces upward are attached to lower sides of the first and second air intakes 19a and 19b, respectively, provided upstream of the supercharger cooler 13 in the cooling air flowing direction, to direct cooling air flowing in through the first and second air intakes 19a and 19b toward the supercharger cooler 13. The louvers 21 allow cooling air to flow toward the supercharger cooler 13, enabling cooling air flowing in through the first and second air intakes 19a and 19b to be reliably supplied to the supercharger cooler 13. On the other hand, the air conditioning condenser 14 disposed below the supercharger cooler 13 is supplied with cooling air flowing in through the third air intake 19c. In the figures, reference numeral denotes 21a denotes a louver attachment section for attaching the louver 21 to the side cover 19. Furthermore, the louver 21 attached to the lower side of the first air intake 19a is divided into two portions at a horizontally intermediate portion of the first air intake 19a in order to avoid interference with the air cleaner 20.

On the other hand, an upper side of the engine room 7 is covered with an openable and closable engine hood 22 located above the engine 9 and the cooling unit 11. A grating 23 is installed on an upper surface portion of the engine room 7 (corresponding to an upper surface portion of a building cover according to the present invention) extending from the left of the engine hood 22 to the side cover 19. The grating 23 includes a frame body 23a in which a plurality of parallel flat bars 23b is incorporated with gaps present between the flat bars 23b. The gaps between the flat bars 23b form air intakes 23c through which air is taken into the engine room 7. Thus, the air intakes 23c are formed in the upper surface portion of the engine room 7 located upstream of the cooling unit 11 in the cooling air flowing direction. In this case, in order to direct cooling air flowing in through the air intakes 23c between the flat bars 23b toward the supercharger cooler 13, each of the flat bars 23b is inclined such that a leading end side of the flat bar 23b faces the supercharger cooler 13 and is formed to have a larger vertical length than the frame body 23a. The inclined flat bars 23b allow cooling air to flow toward the supercharger cooler 13, enabling cooling air flowing in through the air intakes 23c in the upper surface portion of the engine room 7 to be reliably supplied to the supercharger cooler 13. According to the embodiment, the inclined flat bars 23b of the grating 23 correspond to a louver provided on the air intake in the upper surface portion of the building cover according to the present invention.

Furthermore, in front of the grating 23, an air cleaner attachment section 24 is formed integrally with the grating 23. The air cleaner attachment section 24 is penetrated by a pipe 20b extending from the pre-cleaner 20a to the air cleaner 20. The pre-cleaner 20a is arranged above the air cleaner attachment section 24, and the air cleaner 20 is attached to and supported by a lower side of the air cleaner attachment section 24.

Moreover, a support plate 25 opposite and parallel to the upper surface portion 13b of the supercharger cooler 13 via a gap is attached to the right side frame body 23a of the grating 23. A left edge portion of the openable and closable engine hood 22 abuts against an upper surface of the support plate 25 from above. The support plate 25 includes a regulation plate 26 formed integrally with the support plate 25 and extending to the upper surface portion 13b of the supercharger cooler 13 to close the gap between the support plate 25 and the supercharger cooler 13 upper surface portion 13b. The regulation plate 26 restrains cooling air flowing in through the air intakes 23c of the grating 23 from escaping toward above the supercharger cooler 13 through the gap between the support plate 25 and the supercharger cooler 13 upper surface portion 13b without passing through the supercharger cooler 13. Furthermore, the cooling air restrained by the regulation plate 26 from flowing upward is introduced into the supercharger cooler 13. In this manner, the regulation plate 26 is provided above the supercharger cooler 13 to regulate a flow of cooling air flowing in through the air intakes 23c of the grating 23 and toward above the supercharger cooler 13 to introduce the cooling air into the supercharger cooler 13.

On the other hand, reference numeral 27 denotes an attachment plate (corresponding to an attachment member according to the present invention) for attaching the air conditioning condenser 14 disposed below the supercharger cooler 13 to the frame 12 of the cooling unit 11. The attachment plate 27 includes a left attachment side 27a and a right attachment side 27b to which a left end and a right end of the air conditioning condenser 14 are attached, and an upper side 27c that couples upper portions of the left attachment side 27a and the right attachment side 27b together. Moreover, the attachment plate 27 includes a current plate 28 integrally attached to an upper end portion of an upper side 27c of the attachment plate 27 and projecting horizontally toward the side cover 19. The current plate 28 restrains cooling air flowing in through the first and second air intakes 19a and 19b in the side cover 19 and the air intakes 23c in the grating 23, provided upstream of the supercharger cooler 13 in the cooling air flowing direction, from flowing toward below the supercharger cooler 13. Furthermore, cooling air restrained from flowing downward by impinging on the current plate 28 is introduced into the supercharger cooler 13. As described above, the current plate 28 is provided below the supercharger cooler 13 to restrain a flow of cooling air flowing in through the first and second air intakes 19a and 19b in the side cover 19 and the air intakes 23c in the grating 23 and toward below the supercharger cooler 13 to introduce the cooling air into the supercharger cooler 13.

In this way, cooling air flowing in through the air intakes 23c in the grating 23 installed on the upper surface portion of the engine room 7 is directed toward the supercharger cooler 13 by the inclined flat bars 23b. Furthermore, cooling air flowing in through the first and second air intakes 19a and 19b in the side cover 19 is directed toward the supercharger cooler 13 by the louver 21. Moreover, the regulation plate 26 provided above the supercharger cooler 13 regulates the flow of cooling air flowing in through the air intakes 23c in the grating 23 and toward above the supercharger cooler 13. Additionally, the current plate 28 provided on the lower side of the supercharger cooler 13 regulates the flow of cooling air flowing in through the air intake 23c in the grating 23 and the first and second air intakes 19a and 19b in the side cover 19 and toward below the supercharger cooler 13. This allows a needed amount of cooling air to be supplied to the supercharger cooler 13 even when the air cleaner 20 is disposed upstream of the supercharger cooler 13 in the cooling air flowing direction.

In the embodiment configured as described above, the hydraulic shovel 1 includes the plurality of heat exchangers such as the supercharger cooler 13, the air conditioning condenser 14, the radiator 15, and the oil cooler 16 disposed together in the engine room 7 as the cooling unit 11, and the air intakes 23c formed in the upper surface portion of the engine room 7 (the upper surface portion of the building cover) located upstream of the cooling unit 11 in the cooling air flowing direction and the air intakes 19a, 19b, and 19c formed in the side cover 19 (the side surface portion of the building cover) (the air intakes 23c formed in the grating 23 installed on the upper surface portion of the engine room 7 and the first, second, and third air intakes 19a, 19b, and 19c formed in the side cover 19). The plurality of heat exchangers in the cooling unit 11 is arranged as follows. The supercharger cooler 13 and the air conditioning condenser 14 are disposed most upstream in the cooling air flowing direction, and the supercharger cooler 13 is disposed above the air conditioning condenser 14. Furthermore, the current plate 28 is provided below the supercharger cooler 13 to regulate the flow of cooling air flowing in through the air intakes 23c, 19a, and 19c positioned upstream of the supercharger cooler 13 in the cooling air flowing direction (the air intakes 23c formed in the grating 23 installed on the upper surface portion of the engine room 7 and the first and second air intakes 19a and 19b formed on the upper half side of the side cover 19) and toward below the supercharger cooler 13 to introduce the cooling air into the supercharger cooler 13.

As a result, the current plate 28 allows cooling air flowing in through the air intakes 23c, 19a, and 19c located upstream of the supercharger cooler 13 in the cooling air flowing direction to be restrained from flowing toward below the supercharger cooler 13 so that the cooling air can be introduced into the supercharger cooler 13. Thus, even when a member obstructing the flow of cooling air, like the air cleaner 20 in the embodiment, is disposed upstream of the supercharger cooler 13 in the cooling air flowing direction, a needed amount of cooling air can be reliably supplied to the supercharger cooler 13. When the needed amount of cooling air is supplied to the supercharger cooler 13, a needed amount of cooling air can also be supplied to the radiator 15 and the oil cooler 16 both disposed downstream of the supercharger cooler 13 in the cooling air flowing direction.

In the embodiment, the current plate 28 is attached to the upper end portion of the attachment plate 27 used for attaching, to the frame 12 of the cooling unit 11, the air conditioning condenser 14 disposed below the supercharger cooler 13. Thus, the current plate 28 can be easily provided utilizing the attachment plate 27 for the air conditioning condenser 14 without the need for a dedicated attachment member or space for attachment of the current plate 28. The embodiment can contribute to simplifying the structure of the construction machine and reducing the costs of the construction machine.

In the embodiment, the regulation plate 26 is provided above the supercharger cooler 13 to regulate the flow of cooling air flowing in through the air intakes 23c in the upper surface portion of the engine room 7 and toward above the supercharger cooler 13 to introduce the cooling air into the supercharger cooler 13. Thus, the regulation plate 26 allows prevention of waste of a flow, toward above the supercharger cooler 13, of cooling air flowing in through the air intakes 23c in the upper surface portion of the engine room 7. This enables an increase in the amount of cooling air supplied to the supercharger cooler 13.

In the embodiment, the air intakes 23c in the upper surface portion of the engine room 7 are formed in the grating 23 installed on the upper surface portion of the engine room 7, and the regulation plate 26 is attached to the grating 23. As a result, the regulation plate 26 can be easily provided utilizing the grating 23 without the need for a dedicated attachment member or space for attachment of the regulation plate 26. The embodiment can contribute to simplifying the structure of the construction machine and reducing the costs of the construction machine.

In the embodiment, the first and second air intakes 19a and 19b in the side cover 19 are provided with the louvers 21 for directing cooling air flowing in through the first and second air intakes 19a and 19b toward the supercharger cooler 13. As a result, the supercharger cooler 13 can be reliably supplied with cooling air flowing in through the first and second air intakes 19a and 19b in the side cover 19 positioned upstream of the supercharger cooler 19 in the cooling air flowing direction.

In the embodiment, the air intakes 23c in the upper surface portion of the engine room 7 are provided with the louvers (inclined flat bars 23b) for directing cooling air flowing in through the air intakes 23c toward the supercharger cooler 13. As a result, the supercharger cooler 13 can be reliably supplied with cooling air flowing in through the air intakes 23c in the upper surface portion of the engine room 7 located upstream of the supercharger cooler 19 in the cooling air flowing direction.

Moreover, the louvers provided in the air intakes 23c in the upper surface portion of the engine room 7 are formed by inclining the flat bars 23b of the grating 23 forming the air intakes 23c. As a result, the louvers can be formed using the flat bars 23b of the grating 23 without the need for a separate member or space for the louvers. The embodiment can contribute to simplifying the structure of the construction machine and reducing the costs of the construction machine.

### INDUSTRIAL APPLICABILITY

The present invention can be utilized for a case where a construction machine such as a hydraulic shovel includes a plurality of heat exchangers including a supercharger heat exchanger and mounted together in the construction machine as a cooling unit.

### EXPLANATION OF REFERENCE NUMERALS

7 Engine room

11 Cooling unit

12 Frame

13 Supercharger cooler

14 Air conditioning condenser

15 Radiator

16 Oil cooler

19 Side cover

19a, 19b, 19c First, second, and third air intakes

20 Air cleaner

21 Louver

23 Grating

23b Flat bar

23c Air intake

26 Regulation plate

27 Attachment plate

28 Current plate

1. A construction machine in which a plurality of heat exchangers including a supercharger heat exchanger is disposed in a building cover as a cooling unit, and air intakes are formed in an upper surface portion and a side surface portion of the building cover located upstream of the cooling unit in a cooling air flowing direction, wherein the plurality of heat exchangers in the cooling unit is arranged in such a manner that upstream side heat exchangers including the supercharger heat exchanger are disposed most upstream in the cooling air flowing direction and that the supercharger heat exchanger is disposed at a highest position among the upstream side heat exchangers, and a current plate is provided below the supercharger heat exchanger, the current plate regulating a flow of cooling air flowing in through the air intake located upstream of the supercharger heat exchanger in the cooling air flowing direction and toward below the supercharger heat exchanger to introduce the cooling air into the supercharger heat exchanger.

2. The construction machine according to claim 1, wherein the current plate is attached to an upper end portion of an attachment member for attaching the heat exchanger disposed below the supercharger heat exchanger to a frame of the cooling unit.

3. The construction machine according to claim 1, wherein a regulation plate is provided above the supercharger exchanger, for regulating a flow of cooling air flowing in through the air intake in the upper surface portion of the building cover and toward above the supercharger heat exchanger to introduce the cooling air into the supercharger heat exchanger.

4. The construction machine according to claim 3, wherein the air intake in the upper surface portion of the building cover is formed in a grating installed on the upper surface portion of the building cover, and the regulation plate is attached to the grating.

5. The construction machine according to claim 1, wherein a louver for directing cooling air flowing in through the air intake toward the supercharger heat exchanger is provided in the air intake in the side surface portion of the building cover located upstream of the supercharger heat exchanger in the cooling air flowing direction.

6. The construction machine according to claim 1, wherein a louver for directing cooling air flowing in through the air intake toward the supercharger heat exchanger is provided in the air intake in the upper surface portion of the building cover.

7. The construction machine according to claim 6, wherein the air intake in the upper surface portion of the building cover is formed by a gap between flat bars of a grating installed on the upper surface portion of building cover, and the flat bars are tilted to form the louver.

8. The construction machine according to claim 2, wherein a regulation plate is provided above the supercharger exchanger, for regulating a flow of cooling air flowing in through the air intake in the upper surface portion of the building cover and toward above the supercharger heat exchanger to introduce the cooling air into the supercharger heat exchanger.

9. The construction machine according to claim 8, wherein the air intake in the upper surface portion of the building cover is formed in a grating installed on the upper surface portion of the building cover, and the regulation plate is attached to the grating.

10. The construction machine according to claim 2, wherein a louver for directing cooling air flowing in through the air intake toward the supercharger heat exchanger is provided in the air intake in the side surface portion of the building cover located upstream of the supercharger heat exchanger in the cooling air flowing direction.

11. The construction machine according to claim 2, wherein a louver for directing cooling air flowing in through the air intake toward the supercharger heat exchanger is provided in the air intake in the upper surface portion of the building cover.

12. The construction machine according to claim 11, wherein the air intake in the upper surface portion of the building cover is formed by a gap between flat bars of a grating installed on the upper surface portion of building cover, and the flat bars are tilted to form the louver.

13. The construction machine according to claim 3, wherein a louver for directing cooling air flowing in through the air intake toward the supercharger heat exchanger is provided in the air intake in the side surface portion of the building cover located upstream of the supercharger heat exchanger in the cooling air flowing direction.

14. The construction machine according to claim 3, wherein a louver for directing cooling air flowing in through the air intake toward the supercharger heat exchanger is provided in the air intake in the upper surface portion of the building cover.

15. The construction machine according to claim 14, wherein the air intake in the upper surface portion of the building cover is formed by a gap between flat bars of a grating installed on the upper surface portion of building cover, and the fiat bars are tilted to form the louver.

16. The construction machine according to claim 4, wherein a louver for directing cooling air flowing in through the air intake toward the supercharger heat exchanger is provided in the air intake in the side surface portion of the building cover located upstream of the supercharger heat exchanger in the cooling air flowing direction.

17. The construction machine according to claim 4, wherein a louver for directing cooling, air flowing in through the air intake toward the supercharger heat exchanger is provided in the air intake in the upper surface portion of the building cover.

18. The construction machine according to claim 17, wherein the air intake in the upper surface portion of the building cover is formed by a gap between flat bars of a grating installed on the upper surface portion of building cover, and the flat bars are tilted to form the louver.

19. The construction machine according to claim 5, wherein a louver for directing cooling air flowing in through the air intake toward the supercharger heat exchanger is provided in the air intake in the upper surface portion of the building cover.

20. The construction machine according to claim 19, wherein the air intake in the upper surface portion of the building cover is formed by a gap between flat bars of a grating installed on the upper surface portion of building cover, and the flat bars are tilted to form the louver.
